(19) United States
(12) Patent Application Publication
(10) Pub. No.: US 2026/0278450 A1
(43) Pub. Date: Sep. 17, 2026

(54) QUANTUM ERROR CORRECTION METHOD AND APPARATUS

(71) Applicant: Riverlane Ltd., Cambridge (GB)

(72) Inventors: Ben BARBER, Cambridge (GB); Kenton BARNES, Cambridge (GB); Luka SKORIC, Cambridge (GB)

(21) Appl. No.: 19/043,277

(22) Filed: Jan. 31, 2025

Related U.S. Application Data
(63) Continuation of application No. PCT/GB2024/051056, filed on Apr. 24, 2024.

(30) Foreign Application Priority Data
Apr. 28, 2023 (GB) 2306312.6

(51) Int. Cl. G06N 10/70; G06N 10/40

(52) U.S. Cl. CPC G06N 10/70; G06N 10/40

(57) ABSTRACT

A quantum error correction method and a quantum computing system are disclosed. A decoding system of the quantum computing system receives an error syndrome representative of an error state of qubits in the quantum computing system and determines that a probability of successfully correcting the error state fails to satisfy a predetermined success criterion. The decoding system sends a signal to a control system of the quantum computing system to indicate that the success probability fails to satisfy the predetermined success criterion, and the control system determines whether to modify a quantum computation being performed on the qubits.

### FIELD OF THE INVENTION

The present invention relates to quantum error correction.

### BACKGROUND

Quantum computers have the potential to perform computations that would be intractable on even the most powerful classical computers.

Instead of representing information using classical bits, quantum computers generally use qubits, which can be in a simultaneous superposition of multiple quantum states. Qubits generally exhibit much higher error rates than the bits used in classical computers, and quantum computers therefore require the use quantum error correction in order to identify and correct qubit errors.

While quantum error correction schemes can be used to reduce the incidence of logical errors, there may be occasions where errors can only be corrected with low confidence, which leads to an increased risk of logical error and consequential failure of the quantum computation.

There is a need for improved quantum error correction methods that mitigate against the risk of computational failures resulting from low-confidence error corrections.

### SUMMARY OF THE INVENTION

According to a first aspect of the invention, there is provided a quantum error correction method in a quantum computing system comprising a control system communicatively coupled to a decoding system, the method comprising: receiving, at the decoding system from the control system, an error syndrome representative of an error state of a plurality of qubits in the quantum computing system; determining, at the decoding system, that a probability of successfully correcting the error state fails to satisfy a predetermined success criterion; sending, from the decoding system to the control system, a signal indicative that the probability of successfully correcting the error state fails to satisfy the predetermined success criterion; responsive to receiving the signal, determining, at the control system, whether to modify a quantum computation being performed on the plurality of qubits.

The method of the present disclosure facilitates shorter overall quantum computations (i.e. a reduction in total quantum computing operations) required for a successful quantum computation (i.e. a quantum computation without logical errors) by allowing the quantum computation to be modified when the probability of successful correction (and therefore the accuracy of the quantum computation) is unacceptably low. For example, aborting and restarting a quantum computation that is unlikely to succeed will require fewer quantum operations in total compared to restarting the quantum computation once it is complete (e.g. restarting the quantum computation when it becomes apparent at the end of the quantum computation that the result of the quantum computation is incorrect).

A successful correction is any correction that results in the encoded qubits being in the correct logical state. As will be appreciated by one skilled in the art, such a correction does not necessarily need to exactly reverse the physical qubit errors that have occurred in order to be successful.

The quantum computation being performed on the plurality of qubits could be a complete (i.e. self-contained) quantum computation or a subroutine in a larger quantum computation (e.g. part of a magic state distillation routine, or part of some other quantum computation involving only a subset all logical qubits involved in the larger quantum computation).

The decoding system is configured to decode error syndromes, and the control system is configured to send control signals to, and to receive measurement outputs from, physical qubits (possibly via intermediate devices and systems). The decoding system and the control system may be separate physical systems, subsystems of a single physical system, or separate software components within a physical system. The decoding system may optionally be a subsystem of the control system. The control system and the decoding systems may comprise further subsystems.

Communicatively coupled means that communications (e.g. signals, information etc.) can be sent between the decoding system and the control system. This communication may be direct or indirect (e.g. via one or more intermediate systems), and it may be via a physical or virtual channel, e.g. a wired connection, wireless connection, software interface etc.

The quantum computation may be any computation which is at least partly performed using the plurality of qubits. The quantum computation may additionally involve classical processing on a classical computing device (e.g. a classical central processing unit).

The determination whether to modify the quantum computation may be based on an amount of the quantum computation remaining to be performed. For example, the determination whether to modify the quantum computation may be based on the proportion (i.e. actual or expected proportion) of the quantum computation that remains (the actual proportion of the quantum computation that remains may be unknown in dynamic quantum computations). Determining whether to modify the quantum computation may comprise determining whether the proportion of the quantum computation that remains exceeds a predefined threshold value (which may be decided analytically or numerically based on a required accuracy or reliability of the quantum computation) and modifying (e.g. restarting or aborting) the quantum computation if it does. The amount of the quantum computation remaining to be performed may be calculated using the number of steps (or timesteps) remaining in the quantum computation, or it may be based on an expected amount of time (e.g. proportional to expected total computation time) remaining in the quantum computation.

Taking account of the amount of the quantum computation remaining to be performed facilitates a reduction in the total number of quantum operations by allowing the quantum computation to be modified (e.g. restarted) if there is a large proportion of the quantum computation remaining (rather than using quantum resources to first complete an unreliable quantum computation that is less likely to succeed).

Alternatively, the control system may always modify the quantum computation regardless of the current stage of the computation. While this approach may not reduce the expected total number of operations as much as taking account of the amount of the computation remaining, it nonetheless enables a reduction in the total number of operations compared to conventional techniques by modifying quantum computations that are unlikely to succeed. This approach may be particularly well-suited to scenarios in which it is unlikely that the probability of successfully correcting the error state will fail to satisfy the predetermined success criterion, because a new (i.e. restarted) quantum computation is more likely to provide an accurate result (i.e. it is unlikely that further scenarios will occur in which the probability of successfully correcting the error state fails to satisfy the predetermined success criterion).

The predetermined success criterion can be any criterion that can be used to detect occurrences of low-confidence error corrections (i.e. corrections that would not provide the desired quantum computing reliability). The success criterion may be set based on a required quantum computing reliability or accuracy, for example a threshold probability value of successfully correcting the error state may be used. Possible success criteria include, inter alia: the probability of successful correction exceeding a predefined threshold value (e.g. 50%, 60%, 70% etc.), no arbitrary decisions being made when selecting a correction operation (i.e. no ambiguous scenarios arise during the decoding, such as spanning clusters when using union-find decoding), no equal-weight minimum-weight error correction operations occur during decoding that lead to different logical outcomes (e.g. in topological quantum error correction codes that use matching techniques such as minimum weight perfect matching).

The method may further comprise maintaining, at the control system, a count of how many signals have been received indicative that the probability of successfully correcting the error state fails to satisfy the predetermined success criterion, wherein the determination whether to modify the quantum computation is based on the count.

For example, determining whether to modify the quantum computation may comprise determining whether the count exceeds a predefined maximum count value, and modifying the quantum computation if it does. The predefined maximum count value may be based upon the amount (e.g. absolute amount or proportional amount) of the quantum computation that remains (i.e. based on a current stage of the quantum computation). For example, the control system may obtain the predefined maximum count value from a lookup table based on the amount of the quantum computation that remains.

The count effectively acts as a proxy for the cumulative logical error probability (and therefore the accuracy/reliability of the quantum computation). Modifying the quantum computation based on the count therefore enables the quantum computation to be modified if the accuracy becomes unacceptably low.

Additionally and/or alternatively, the method may further comprise maintaining a complete history of signals received that are indicative that the probability of successfully correcting the error state fails to satisfy the predetermined success criterion, and optionally also storing data associated with those signals (e.g. the probability of successfully correcting the error state). The count may optionally be maintained by maintaining the complete history of all signals (i.e. the count may be the number of signals maintained in the history). Maintaining a complete history has the advantage that the decision of whether to modify the quantum computation could be made based on aggregated data derived from the history, e.g. a rolling average.

Determining whether to modify the quantum computation being performed on the plurality of qubits may comprise determining, by the control system, a logical error probability value, wherein the determination whether to modify the quantum computation comprises determining whether the logical error probability value exceeds a predefined maximum logical error probability value (e.g. the quantum computation may be modified if the logical error probability exceeds the predefined maximum logical error probability value). The logical error probability value may be based on the count of how many signals have been received indicative that the probability of successfully correcting the error state fails to satisfy the predetermined success criterion. Alternatively, the signal may comprise a value for the probability of successfully correcting the error state, and the determination whether to modify the quantum computation may be based on comparing whether the probability value (or a cumulative probability value calculated over multiple error syndrome cycles (i.e. rounds of syndrome measurement)) exceeds a predefined logical error probability threshold (e.g. the computation may be modified (aborted or restarted) if the cumulative probability value exceeds the predefined logical error probability threshold).

Modifying the quantum computation based on a logical error probability value provides a balance between quantum computing accuracy (i.e. logical error rate) and the total number of quantum operations. Using a lower maximum logical error probability value is likely to avoid resets (and therefore reduce the total number of quantum operations) at the cost of a lower quantum computational accuracy.

The method may further comprise identifying, at the decoding system, a proposed correction operation based on the error syndrome. The proposed correction may be identified subsequent to determining that the probability of successfully correcting the error state fails to satisfy the predetermined success criterion. For example, the proposed correction may only be identified in response to an indication from the control system that the quantum computation is to proceed. In methods such as union-find decoding, it is possible to identify ambiguous (i.e. low-confidence) corrections based on the occurrence of a spanning cluster without necessarily finding a proposed correction (similar ambiguous/low-confidence correction can also occur in minimum-weight perfect matching decoding, as explained in Yue We et al, arXiv:2211.03288v1 [quant-ph]).

The method may further comprise sending, from the decoding system to the control system, the proposed correction operation. The control system may optionally apply the proposed correction operation to the physical qubits, or the control system may alternatively keep track of all correction operations and make appropriate adjustments to logical operations and qubit measurement outcomes. The proposed correction operation may only be sent to the control system in certain scenarios, e.g. when requested by the control system.

The signal may optionally comprise a value indicating the probability of successfully correcting the error state. Calculation of the actual value of the probability of successfully correcting the error state is optional, especially in scenarios such as union-find decoding where the occurrence of a spanning cluster can be used as an indication that any proposed correction operation has a relatively low confidence. Sending the probability value to the control system allow the control system to make a more informed decision about whether to modify the quantum computation. For example, the control system may maintain a cumulative probability of logical error based on the received probability values in multiple syndrome measurement cycles.

Modifying the quantum computation may also be referred to as adjusting or altering the quantum computation (i.e. in some way causing the existing quantum computation to be changed). The modification may apply to all or a subset of qubits involved in the quantum computation (e.g. the modification may only apply to a subroutine in a larger quantum computation).

Modifying the quantum computation may comprise aborting the quantum computation or restarting (also referred to as resetting) the quantum computation. In general, restarting the quantum computation will require aborting the existing quantum computation (although a new quantum computation could alternatively be started concurrently with the existing quantum computation if there are sufficient resources). Alternatively, other modifications could be made. For example, the quantum computation could be modified in such a way that the error state of certain logical qubits does not have a detrimental effect on the overall computation (e.g. by opting not to use certain logical qubits in a magic state distillation process, by restarting only a subset of logical qubits (rather than the entire computation), or adjusting the distance of the code for one or more logical qubits). One skilled in the art will appreciate that there are numerous ways in which the quantum computation could be modified, and that the decision of how (and whether) to modify the quantum computation will depend upon the details of the quantum computation being performed.

Determining that the probability of successfully correcting the error state fails to satisfy the predetermined success criterion may comprise determining, at the decoding system, the probability of successfully correcting the error state; and determining, at the decoding system, that the probability of successfully correcting the error state is less than a predefined success probability threshold value. The predefined success probability threshold value may be decided based upon the required reliability or accuracy of the quantum computation. Comparing the probability of successfully correcting the error state against a predefined success probability threshold value allows the control system to modify (e.g. restart) the quantum computation if the probability of logical error would be unacceptably high.

Determining that the probability of successfully correcting the error state fails to satisfy the predetermined success criterion may comprise identifying, at the decoder, an ambiguous (i.e. inconclusive) decoding scenario (in other words, the predetermined success criterion may be a requirement that there are no ambiguous decoding scenarios). Ambiguous decoding scenarios are those in which the decoding system cannot confidently (e.g. with probability greater than some predefined threshold) select between correction operations that would lead to different logical outcomes. Ambiguous decoding scenarios therefore increase the probability of a logical error occurring, so flagging this scenario to the control system allows the control system to modify the quantum computation if necessary (e.g. restarting the quantum computation to reduce the likelihood of an incorrect result). For example, the ambiguous decoding scenario could be a spanning cluster in union-find decoding, or two equal-weight minimum-weight corrections in minimum weight perfect matching decoding that lead to different logical outcomes. One skilled in the art will be able to identify other such ambiguous scenarios without undue burden.

Determining whether to modify a quantum computation being performed on the plurality of qubits may comprise determining that the quantum computation should be modified, in which case the method may further comprise modifying, by the control system, the quantum computation.

According to a second aspect of the invention, there is provided a computer program product comprising instructions which, when the program is executed by a quantum computing system, cause the quantum computing system to carry out the method of any preceding claim.

According to a third aspect of the invention, there is provided a computer-readable storage medium (such as a non-transitory computer-readable storage medium) having stored thereon the computer program product of the second aspect.

According to a fourth aspect of the invention, there is provided a quantum computing system comprising a control system communicatively coupled to a decoding system, wherein the quantum computation system is configured to perform the method of the first aspect.

The second, third and fourth aspects of the invention provide the same benefits and advantages as the first aspect of the invention.

### BRIEF DESCRIPTION OF THE DRAWINGS

Examples of the present invention will now be described in detail with reference to the accompanying drawings, in which:

FIG. 1 is a schematic diagram of a quantum computing system;

FIG. 2 is schematic diagram of a quantum error correction method;

FIGS. 3a-c illustrate a quantum error correction method using minimum weight perfect matching decoding; and

FIGS. 4a-c illustrate a quantum error correction method using union-find decoding.

### DETAILED DESCRIPTION

Quantum error correction algorithms are used to detect and correct errors at the physical qubit level to mitigate against computational errors at the logical qubit level. Quantum error correction is expected to be essential for performing useful computations on early quantum computers, and the delicate nature of qubits means that quantum error correction is likely to remain necessary even once quantum computing hardware matures.

While quantum error correction schemes can be used to confidently correct errors on qubits that have sufficiently low physical error rates, there may be occasions on which a correction can only be identified with low confidence (e.g. when operating with a physical error rate which is close to the error threshold of the quantum error correction code being used, which is likely to be the case for early quantum computers). For example, an error decoder may identify two alternative corrections that are equally likely (or almost equally likely) to correct detected physical qubit errors: one of these corrections may successfully correct the detected errors, whereas the other may lead to a logical error. In order to continue the quantum computation, one of the proposed corrections must be selected arbitrarily. If the wrong correction is selected then the most likely outcome is failure of the quantum computation.

There may be also occasions on which one correction is most likely to correct the detected errors but is still below a desired level of confidence required for reliable quantum computation. For example, a proposed correction may only have a 75% confidence level, implying that there is a one in four chance of a logical error resulting from the correction, which may be considered unacceptable depending upon the details of the quantum computation being performed.

The inventors of the present disclosure have recognised that the level of confidence (i.e. the probability of successfully correcting physical qubit errors) can be used to inform how to proceed with an ongoing quantum computation.

In many cases, it will be preferable to abort and restart a quantum computation when a low-confidence correction is identified. For example, in scenarios where it is impossible to verify whether the result of the quantum computation is correct, applying a low-confidence correction will reduce confidence in the final result. In addition, even where is it possible to verify the result, it may be more efficient to restart a quantum computation than to proceed (especially at an early stage in the quantum computation when there may be many hours or days of the quantum computation remaining).

However, there are also scenarios in which it may be worth proceeding with the quantum computation, especially when the final result can be verified (e.g. when solving NP problems using a quantum computer) and/or when the quantum computation is at a relatively late stage (i.e. a relatively small proportion of the quantum computation remains to be performed).

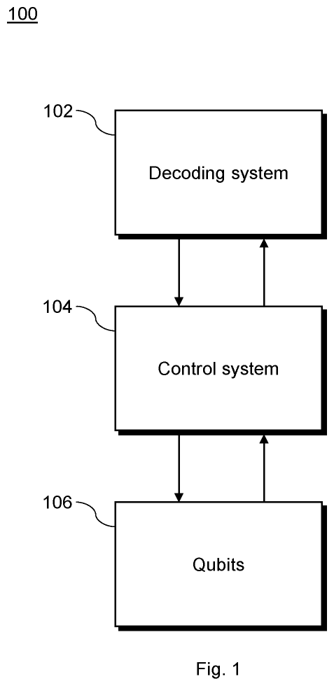

FIG. 1 shows a schematic of a quantum computing system 100 (also referred to as a quantum processing unit, QPU) comprising a control system 104 communicatively coupled to a decoding system 102 (also referred to as a decoder) and to a plurality of qubits 106. Unless indicated otherwise, reference to a “qubit” or “qubits” herein should be understood to refer to physical qubits (as opposed to logical qubits).

The qubits 106 may utilise any suitable qubit architecture, including (but not limited to) superconducting architectures, silicon architectures, photonic architectures etc. While the present disclosure refers primarily to qubits, any reference to qubits herein should be understood to also include qudits, i.e. quantum information units with more than two computational basis states (such as qutrits, which have three computational basis states).

The control system 104 is configured to send control signals to the qubits 106 for performing operations on the qubits 106 (such as logic gates and measurements) and to receive output signals from the qubits 106 (i.e. outputs of measurement operations performed on the qubits 106). The control system 104 may optionally be divided into additional subsystems, such as an algorithmic control subsystem responsible for high level processing (i.e. at the algorithmic level) and a physical control subsystem responsible for low level processing (e.g. converting algorithmic commands from the algorithmic control subsystem into qubit control pulses etc. and converting output signals from the qubits 106 into measurement values).

While the decoding system 102 and control system 104 are illustrated as being separate components, it should be understood that they could both be subcomponents of a single system. For example, the decoding system 102 and control system 104 could be hardware subcomponents of a single hardware system responsible for control and decoding. Alternatively, the decoding system 102 and control system 104 could be separate software components executed on a single hardware system (or across a distributed system).

In use, quantum computations are executed on the qubits 106 controlled by the control system 104. Due to the fragile nature of quantum information states, non-trivial quantum computations will generally require the use of quantum error correction. Myriad quantum error correction schemes have been proposed (Terhal, B. M. Quantum error correction for quantum memories. Rev. Mod. Phys. 87, 307-346 (2015) provides a review of some of the most prominent quantum error correction schemes), and the present disclosure will focus primarily on surface codes, which are stabiliser codes that encode logical qubits in networks of physical qubits using topological properties that arise from the measurements used to obtain error syndromes. However, it should be understood that the teachings of the present disclosure can also be applied other quantum error correction codes where scenarios may arise in which errors can only be corrected with low confidence.

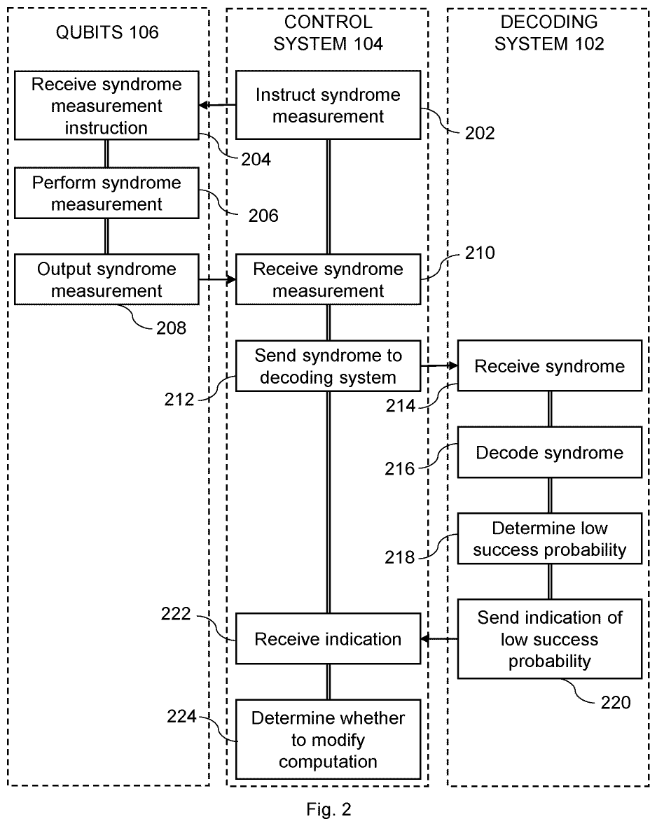

FIG. 2 shows a schematic of a quantum error correction method performed by the quantum computing system 100. At step 202, the control system 104 instructs a syndrome measurement on the qubits 106. The instruction may be sent as an electromagnetic pulse sequence (e.g. a microwave pulse sequence) along one or more control lines. The signal may optionally be split by one or more multiplexers for transmission to different qubits. The syndrome measurement instruction is received by the qubits 106 in step 204 and causes a syndrome measurement operation to be performed on at least a subset of the qubits 106 in step 206.

The syndrome measurement outcome is output from the qubits 106 in step 208 (e.g. as one or more electromagnetic signals) and received by the control system 104 in step 210. The control system 104 preferably processes the raw syndrome measurement signal to convert it into a format suitable for processing by the decoding system 102 (e.g. into a data structure indicating measurement outcome values for different stabiliser measurements of the quantum error correction code). The syndrome is representative of an error state of the physical qubits 106. The syndrome itself may be erroneous (e.g. due to measurement errors), so multiple rounds/cycles of syndrome measurement may be performed to account for erroneous measurement values.

The syndrome is sent by the control system 104 in step 212 and received at the decoding system 104 in step 214. The decoding system 102 then decodes the syndrome in step 216 and may optionally identify one or more candidate correction operations for correcting physical qubit errors. Based on the outcome of the decoding step 216, the decoding system 102 will proceed to determine whether the success probability (i.e. the probability of successfully correcting the qubit errors) is low (i.e. it fails to satisfy a predetermined success criterion) in step 218. As will be described in more detail later, the predetermined success criterion could be (among others):
the probability of successful correction exceeding a predefined threshold value, e.g. 50%, 60%, 70% etc.
no arbitrary decisions being made when selecting a correction operation (i.e. no ambiguous scenarios arise during the decoding)
no spanning clusters occur when decoding the syndrome (e.g. in union-find decoding algorithms)
no equal-weight error correction operations occur during decoding that lead to different logical outcomes (e.g. in topological quantum error correction codes that use weight-based matching techniques).

If the decoder 102 determines that the probability of successfully correcting the errors fails to satisfy the predetermined success criterion in step 218 (e.g. for one of the reasons listed above) then the decoder 102 proceeds to send an indication (such as a flag) to the control system 104 indicating that the success probability fails to satisfy the predetermined success criterion in step 220. Alternatively, the decoder 102 may send a quantitative indication to the control system 104 instead of a flag in step 220, e.g. indicating the value of the success probability.

The indication is received by the control system 104 in step 222, and the control system 104 then decides how the quantum computation should proceed in step 224. In particular, the control system 104 determines whether the quantum computation should proceed unhindered or whether the quantum computation should be modified. For example, the control system 104 may decide to abort the entire quantum computation, abort part of the quantum computation, reinitialise/restart the entire quantum computation, or reinitialise one or more logical qubits in the quantum computation.

The determination of whether (and how) to modify the quantum computation may be based upon various factors, including the amount of the quantum computation (e.g. the proportion of the total quantum computation) remaining to be performed. For example, if the amount of the quantum computation that remains is less than a predefined proportion (e.g. 10%), a decision may be made to proceed with the quantum computation. However, if more than the predefined proportion remains, a decision may be made to reinitialise the quantum computation.

The amount of the quantum computation remaining may be determined based on an absolute or proportional remaining time in the quantum computation (which may be an estimated time), an absolute or proportional expected number of steps (or timesteps) remaining in the quantum computation, or an absolute or proportional expected number of operations remaining in the quantum computation. The exact amount of the quantum computation remaining may be unknown (e.g. when the logic gates are non-predetermined before the start of the quantum computation), so the amount of the quantum computation remaining may be an estimated value.

The determination of whether (and how) to modify the quantum computation may also be based on other factors. For example, if it is difficult to verify that the result of the quantum computation is correct then a decision may be made to abort the existing quantum computation regardless of the amount of time remaining.

In addition, the determination of whether to modify the quantum computation may take account of the number of previous indications received by the control system 104. For example, the control system may maintain a count of how many signals have been received indicating that the success probability fails to satisfy the predetermined success criterion (e.g. during previous rounds of quantum error correction). If the count exceeds a predetermined value (which may depend upon the amount of the quantum computation that remains) then a decision may be made to abort the quantum computation.

The signal indicating that the success probability fails to satisfy the predetermined success criterion may contain additional information. For example, the signal may encode a value for the success probability. In this scenario, the control system 104 may decide whether to modify the quantum computation based on this probability value or on a cumulative probability value calculated using probability values received in all error correction cycles during the quantum computation.

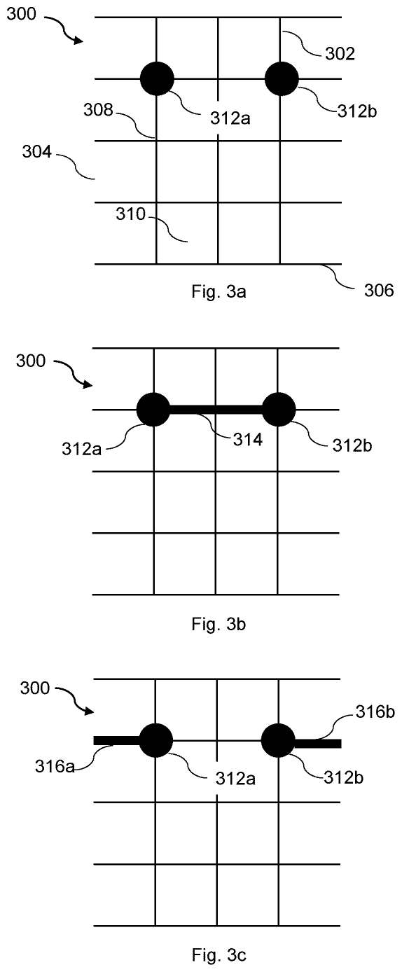

FIGS. 3a-c and 4a-c provide examples of applying the method of the present disclosure to surface code decoders that use minimum weight perfect matching (MWPM) and union-find respectively.

FIG. 3a shows a simple qubit lattice for quantum error correction using the surface code. A detailed summary of quantum error correction with surface codes can be found in Terhal, B. M. Quantum error correction for quantum memories. Rev. Mod. Phys. 87, 307-346 (2015). The standard surface code is defined on a square lattice 300, with each edge 302 of the lattice corresponding to a physical data qubit. The illustrated lattice 300 can be used to encode a single logical qubit collectively across all of the data qubits. There is a “rough” boundary 304 at the left and right of the lattice 300, and a “smooth” boundary 306 at the top and bottom of the lattice 300.

Each vertex 308 of the lattice 300 is associated with a syndrome measurement consisting of a product of Pauli X operations on the data qubits associated with each edge 302 incident on the respective vertex. Similarly, each tile (or plaquette or cell) 310 of the lattice is associated with a syndrome measurement consisting of a product of Pauli Z operations on the data qubits associated with the edges 302 of the plaquette 310. The outcome of all vertex or plaquette syndrome measurements is collectively referred to as a syndrome; additional syndrome measurements can be appended to the syndrome by repeating the syndrome measurements.

While the simple layout of the surface code means that it will often be beneficial to arrange the qubits in a similar physical arrangement to that shown in FIG. 3a, one skilled in the art will appreciate that this is optional and may not be practical nor desirable in certain qubit implementations—corresponding topological properties can be achieved without having physical qubits arranged in this grid-like structure. In addition, further qubits (often referred to as auxiliary qubits) may be used to facilitate syndrome measurements and other operations performed on the data qubits of the surface code.

The syndrome measurements do not provide exact information about which qubits have experienced errors: instead, the syndrome measurements indicate the end points of “chains” of errors on the lattice 300.

The syndrome measurements act as stabilizer operations that project arbitrary computational errors on the physical qubits into Pauli X, Y and Z errors. The syndrome measurement operations associated with each vertex 308 act to detect Pauli Y and Z errors on qubits incident on the respective vertex (i.e. errors that anticommute with the vertex syndrome measurement operation), and the syndrome measurement operations associated with each tile 310 act to detect Pauli X and Y errors on qubits around the respective tile (i.e. errors that anticommute with the tile syndrome measurement operation).

The nature of the surface code means that the vertex and tile syndromes can be decoded independently.

Syndrome measurement outcomes can take two values: in general, a 1 value indicates the detection of an even number of errors on the associated data qubits (e.g. 0, 2 or 4 errors), and a −1 value indicates the detection of an even number of errors on the associated data qubits (e.g. 1 or 3 errors). One skilled in the art will understand that alternative measurement values may be used without loss of generality (e.g. the function of −1 and 1 outcomes may be reversed, or alternative labels may be used such as 0 and 1) and that the values of each syndrome measurement will depend upon factors including how the qubits are initialised. In addition, while the actual syndrome measurement outcome can take one of two values, the physical property being observed during the measurement (e.g. a wave pulse) may not be so clearly discretised; such challenges are well-known in the field and are beyond the scope of this disclosure.

The detected end points of chains of errors are referred to herein as detection events, and the set of all detection events is collectively referred to as the syndrome. In order to mitigate against the effects of physical qubit errors, the decoding system 102 attempts to identify a correction operation by pairing up all detection events in such a way that reduces the probability of a logical error occurring.

For example, the dots 312a and 312b are detection events representing syndrome measurements having measurement values of −1. Assuming the syndrome measurements are correct, the two most likely ways for this syndrome to occur are with errors (i.e. Pauli Y or Z errors) on the two physical data qubits between the detection events 312a and 312b (represented by the line 314 in FIG. 3b) or on the two physical data qubits joining the detection events 312a and 312b to the rough boundaries 304 (as represented by the lines 316a and 316b in FIG. 3c).

One of the most prominent methods for decoding surface code syndromes involves the use of minimum weight perfect matching (MWPM). While one skilled in the art will appreciate that more advanced techniques are generally used in practice (e.g. those that use weighted decoding graphs), basic MWPM routines pair detection events in the syndrome in a way that minimises the total number of physical data qubit corrections required (referred to as the weight of the correction). In the example shown in FIGS. 3a-c, there are two such corrections: the correction 314 shown in FIG. 3b, and the combined correction 316a, 316b shown in FIG. 3c, each of which have a weight of two. However, applying each of these corrections leads to a different logical outcome, so making an arbitrary choice between these corrections will effectively randomise the state of the logical qubit represented by the lattice 300 (in practice it may be possible to use more advanced MWPM that take account of other factors such as the number and weight of alternative but logically equivalent error corrections, so the choice is not necessarily truly arbitrary, but for simplicity it will be assumed that these more advanced techniques are not used in the present example).

In the method of the present disclosure, the decoding system 102 flags this event to the control system 104 so that the control system can determine whether to modify the quantum computation being executed on the qubits 106 (e.g. whether to continue with the quantum computation or to abort or restart it etc.). In this scenario, the predetermined success criterion is that there are no minimum weight logical corrections having the same weight that would lead to different logical corrections (i.e. are not logically equivalent).

One skilled in the art will appreciate that alternative criteria could be used, such as a success probability of the minimum-weight correction operation exceeding a predefined threshold value, and the decoding system 102 could be configured to flag other events to the control system 104. For example, the decoding system 102 could calculate a success probability associated with a proposed correction operation and notify the control system 104 (i.e. by sending a flag) when the success probability is less than a predefined success probability threshold value. In this scenario, the predetermined success criterion is that the calculated success probability exceeds the predefined success probability threshold value. The decoding system 102 may optionally send the success probability value to the control system 104.

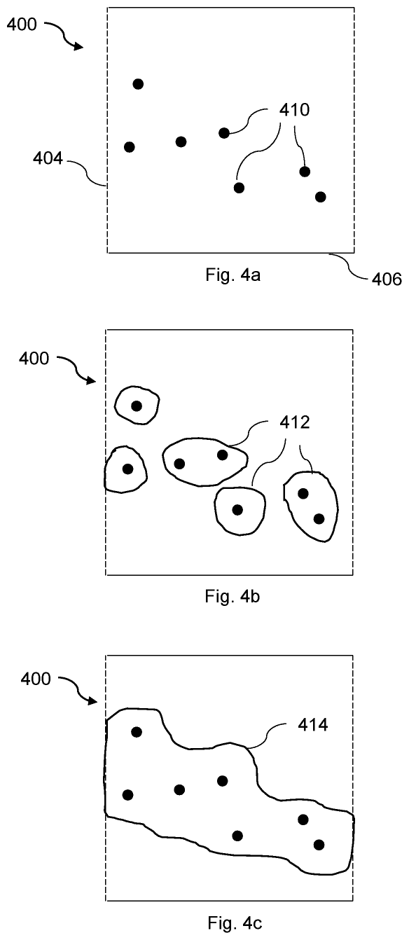

FIGS. 4a-c show another surface code quantum error correction procedure based on union-find rather than MWPM. A detailed summary of union-find surface code decoding can be found in Delfosse & Nickerson, arXiv:1709.06218v3 [quant-ph]. FIG. 4a shows a simplified conceptual illustration of a surface code 400 with the edges of the lattice (corresponding to the data qubits) omitted. The surface code 400 has rough boundaries 404 represented by dashed lines and smooth boundaries 406 represented by solid lines. As in FIGS. 3a-c, detection events 410 are represented by dots in FIGS. 4a-c.

Union-find algorithms involve initially defining clusters 412 of predetermined sizes around each detection event 410, as shown in FIG. 4b. If the clusters 412 of two (or more) detection events 410 touch or overlap, the clusters associated with these detection events 410 are merged into a single cluster. If any of the clusters 412 contain an odd number of detection events 410 and do not touch a rough boundary 404, the sizes of these clusters 412 are increased and the process is repeated until there are no clusters containing an odd number of detection events 410 that do not touch a rough boundary, such as shown in FIG. 4c.

In the example shown in FIG. 4c, there is a single cluster 414 that spans both rough boundaries 404 of the surface code 400. Such clusters (i.e. those that span between rough boundaries of the surface code) will be referred to as spanning clusters. This scenario leads to potential ambiguity in corrections: all detection events 410 must either be paired to another detection event 410 in the cluster 414 or to a rough boundary 404. As there is an odd number of detection events 410 in the illustrated example, at least one detection event 410 must be paired to a rough boundary. However, without using more advanced techniques, a detection event 410 could be paired to either of the rough boundaries 404, and the basic union-find approach does not offer any guidance as to which rough boundary 404 this should be (i.e. the decision as to which boundary to pair to is effectively arbitrary). Pairing to the wrong rough boundary 404 will result in a logical error.

In the method of the present disclosure, the decoding system 102 flags this event (a spanning union-find cluster 414) to the control system 104 so that the control system can determine whether to modify the quantum computation being executed on the qubits 106 (e.g. whether to continue with the quantum computation or to abort or restart it). In this scenario, the predetermined success criterion is that there are no spanning clusters 414.

An exemplary modification strategy will now be described for union-find decoding with the surface code.

There are four distinct decoding scenarios that can arise when decoding errors with union-find: a non-spanning cluster with a correct logical correction, a non-spanning cluster with an incorrect logical correction, a spanning cluster with a correct logical correction, and a spanning cluster with an incorrect logical correction.

The probability of a non-spanning cluster with an incorrect logical correction will be denoted p₁, the probability of a spanning cluster with a correct logical correction will be denoted p₂, and the probability of a spanning cluster with an incorrect logical correction will be denoted p₃. The probability of a non-spanning cluster with a correct logical correction will then be p₀=1−p₁−p₂−p₃. These probabilities are summarised in the following table:

| | Correct logical | Incorrect logical |
|---|---|---|
| | correction | correction |
| Non-spanning cluster | p₀ = 1 − p₁ − p₂ − p₃ | p₁ |
| Spanning cluster | p₂ | p₃ |

The probability of a logical error occurring in a single decoding cycle is then p₁+p₃, and the expected number of logical errors in a quantum computation with C error decoding cycles is (p₁+p₃)C. The actual number of errors will have a Poisson distribution with (p₁+p₃)C as the mean value, such that the probability of zero logical errors occurring is e^{-(p}^{₁}^{+p}^{₃}^{)C}.

Without using the method of the present disclosure, the expected number of repetitions for a successful quantum computation (i.e. no logical errors in all C cycles) would be e^{(p}^{₁}^{+p}^{₃}^{)C}. Conditioned on observing a spanning cluster, the probability of a logical error in a decoding cycle is p₃/(p₂+p₃), which will generally be much higher than the typical case (p₁+p₂+p₃). As a consequence, the occurrence of a spanning cluster when decoding the syndrome provides a strong indication of an increased likelihood of a logical error occurring.

In a straightforward implementation, the control system 104 may decide to modify (e.g. abort or restart) an ongoing quantum computation whenever a spanning cluster occurs. However, it is also possible to implement more advanced techniques that take account of factors such as how much of the quantum computation remains and how many spanning events have already been observed.

For example, let Θ(s,t) represent the expected number of computational steps required to successfully complete the ongoing quantum computation when s spanning events have occurred and t steps have already been performed. After the final timestep, T, either all spanning events s_{T} result in no error, which has probability

$${( \frac{{p}_{2}}{{p}_{2} + {p}_{3}} )}^{{S}_{T}} ,$$

or a reset will be required. Therefore,

$$Θ ( {s}_{T} , T ) = ( 1 - {( \frac{{p}_{2}}{{p}_{2} + {p}_{3}} )}^{{S}_{T}} ) \times Θ ( 0 , 0 ) ,$$

where Θ(0, 0) represents the cost of resetting (i.e. starting at t=0 with no spanning errors).

At each stage of the quantum computation, a decision can be made whether to continue with the quantum computation or to modify (i.e. reset) the quantum computation, the latter of which has expected cost Θ(0, 0). The decision as to whether to modify the quantum computation is based on which of these values is lower: if the expected cost to continue is lower, then the quantum computation should continue, otherwise it should be reset.

The expected cost to continue at timestep t is (1+(P(no spans in step t+1)Θ(s, t+1)+P(one span in step t+1)Θ(s+1,t+1)+P(two spans in step t+1)Θ(s+2,t+1)+ . . . ), where P(n spans in step t+1) represents the probability of n spanning events occurring in step t+1. For large values of s=s′, Θ(s′, t+1)≈Θ(0, 0) because it is almost certain that a logical error will occur when there has been a high number of spanning events, such that a reset will almost certainly be necessary. Accordingly, the infinite sum can be truncated beyond some value n=n′, n′>>1, by approximating Σ_{n≥n},P(n spans in step t+1)Θ(s+n, t+1)≈P(n′ or more spans in step t+1)Θ(0, 0). The number of spanning events in step t+1 is Poisson distributed with mean λ=(p₂+p₃)C/T, so P(n′ spans in step t+1)=λ^{n′}e^{-λ}/n′!.

In general, Θ(0, 0) (the cost to reset the quantum computation) will not be known. However, a numerical approximation for Θ(0, 0) can be obtained by iterating with a dynamic upper bound on Θ(0, 0) until the upper bound stabilises. Once determined, the value for Θ(0, 0) can be used to calculate the expected costs to reset and continue the quantum computation after each spanning event, thereby reducing the total expected number of steps compared to conventional approaches that do not modify the quantum computation in response to observing spanning events. Alternatively, a value for Θ(0, 0) can be estimated (e.g. based on similar previous computations) or using any other suitable method.

Predetermined lookup tables may optionally be generated for use when determining whether to continue or reset based on an amount (e.g. proportion or absolute number of steps) of the quantum computation remaining and the number of observed spanning events (or similar events in non-union-find decoders). The lookup tables could be generated analytically (e.g. using the method described above) or numerically (e.g. based on simulations and/or previous computations).

Various methods can be used to decide whether to modify an ongoing quantum computation, and the above example is simply one of numerous possibilities that could be implemented by a person skilled in the art.

While the above method has been described primarily in relation to surface codes, it should be understood that the method could be used in any quantum error correction code where low-confidence corrections (e.g. ambiguous corrections) can arise, including non-topological error correction codes.

The method of the present disclosure may be provided as a computer program product comprising instructions which, when the program is executed by a quantum computing system, cause the quantum computing system to carry out the method of any preceding claim. The computer program product may be on a computer-readable storage medium (e.g. a non-transitory computer-readable storage medium). The computer program may also be provided as instructions for hardware products such as field-programmable gate arrays (FPGAs) or application-specific integrated circuits (ASICs) (e.g. FPGAs and/or ASICs of decoding systems and control systems of a quantum computer).

Unless indicated otherwise or technically infeasible, one or more steps of any method described herein may be omitted (i.e. such steps may be considered optional and do not necessarily need to be performed) and/or performed in a different order (i.e. the order of such steps may be changed).

1. A quantum error correction method in a quantum computing system comprising a control system communicatively coupled to a decoding system, the method comprising:
receiving, at the decoding system from the control system, an error syndrome representative of an error state of a plurality of qubits in the quantum computing system;
determining, at the decoding system, that a probability of successfully correcting the error state fails to satisfy a predetermined success criterion;
sending, from the decoding system to the control system, a signal indicative that the probability of successfully correcting the error state fails to satisfy the predetermined success criterion; and
responsive to receiving the signal, determining, at the control system, whether to modify a quantum computation being performed on the plurality of qubits.

2. The method of claim 1, wherein the determination whether to modify the quantum computation is based on an amount of the quantum computation remaining to be performed.

3. The method of claim 1, further comprising:
maintaining, at the control system, a count of how many signals have been received indicative that the probability of successfully correcting the error state fails to satisfy the predetermined success criterion, wherein the determination whether to modify the quantum computation is based on the count.

4. The method of claim 1, wherein determining, at the control system, whether to modify the quantum computation being performed on the plurality of qubits comprises determining, by the control system, a logical error probability value, wherein the determination whether to modify the quantum computation comprises determining whether the logical error probability value exceeds a predefined maximum logical error probability value.

5. The method of claim 1, further comprising:
identifying, at the decoding system, a proposed correction operation based on the error syndrome; and
optionally sending, from the decoding system to the control system, the proposed correction operation.

6. The method of claim 1, wherein the signal comprises a value indicating the probability of successfully correcting the error state.

7. The method of claim 1, wherein modifying the quantum computation comprises aborting the quantum computation and/or restarting the quantum computation.

8. The method of claim 1, wherein determining that the probability of successfully correcting the error state fails to satisfy the predetermined success criterion comprises:
determining, at the decoding system, the probability of successfully correcting the error state; and
determining, at the decoding system, that the probability of successfully correcting the error state is less than a predefined success probability threshold value.

9. The method of claim 1, wherein determining that the probability of successfully correcting the error state fails to satisfy the predetermined success criterion comprises identifying, at the decoder, an ambiguous decoding scenario.

10. A computer program product comprising instructions which, when the program is executed by a quantum computing system, cause the quantum computing system to carry out the method of claim 1.

11. A computer-readable storage medium having stored thereon the computer program product of claim 10.

12. A quantum computing system comprising a control system communicatively coupled to a decoding system, wherein the quantum computation system is configured to perform the method of claim 1.
